(19) United States
(12) Patent Application Publication
(10) Pub. No.: US 2011/0156861 A1
(43) Pub. Date: Jun. 30, 2011

(54) Electronic Device Including a Wireless Actuator and a Method Thereof

(75) Inventors: Rachid M. Alameh, Crystal Lake, IL (US); Michael D. Kotzin, Buffalo Grove, IL (US); Thomas Y. Merrell, Beach Park, IL (US)

(73) Assignee: MOTOROLA, INC., Schaumburg, IL (US)

(21) Appl. No.: 12/650,680

(22) Filed: Dec. 31, 2009

(51) Int. Cl. G05B 19/02; G10K 11/00

(52) U.S. Cl. 340/4.3; 367/198; 340/13.29

(57) ABSTRACT

Disclosed are electronic devices and methods of electronic devices having a housing including a wireless actuator without an electrical interface, the wireless actuator located on the housing, the wireless actuator being configured to provide tactile feedback and configured to generate an acoustic signal with a unique acoustic signature upon actuation. Included is at least one accelerometer being configured to receive a mechanical or acoustic stimulus and/or an acoustic signal which can include an impulse response being a brief non-periodic and/or non-repeating signal such as a tap or a repeating signal such as a tone, to generate an identifying signal. Also included is a processor configured to receive an identifying signal to generate a control signal based on the received acoustic signal correlated to the acoustic signature. The control signal can provide initiation of any function or application of the device.

### FIELD

Disclosed is an electronic device including a wireless actuator and a method thereof, and more particularly, a device including a wireless actuator without an electrical interface and an accelerometer configured to receive an acoustic signal of the wireless actuator when the wireless actuator is actuated or released or a combination thereof.

### BACKGROUND

Electronic devices may include many features. For example, the makers of mobile communication devices, including those of cellular telephones, are increasingly adding functionality to their devices. Cellular telephones include features such as still and video cameras, video streaming and two-way video calling, email functionality, Internet browsers, music players, FM radios with stereo audio and organizers. Bluetooth enabled cellular telephones may be PC compatible so that files generated or captured on the mobile communication device may be downloaded to a PC. Likewise, data from a PC or other source may be uploaded to the mobile communication device. For example, a cellular user may download music and movies to their mobile communication device as well. Cellular telephones in particular are becoming more than simply mobile communication devices. They are evolving into powerful tools for information management as well as entertainment consoles. Mobile commerce, facilitated generally by mobile phones, can include services such as banking, payment, and ticketing. The emerging technology behind m-commerce may transform the mobile communication device into an electronic wallet.

The control of features of electronic devices may be provided in different manners. For certain features, dedicated buttons or keys may be provided. For example, makers may place buttons on the outside of the housing, such as volume/camera buttons, for quick and easy access. However, such placement could be cumbersome and add cost and complexity to form factor designs since a dedicated button requires an electronic interface and routing to internal circuitry.

It would be considered an improvement in the art, to provide a method and electronic device with a wireless actuator being free from being electrically connected or requiring electrical routing to a circuit board, and having a desired acoustic signature, for simplified placement on or around a periphery of the electronic device, for simplified or blind activation by a user.

### BRIEF DESCRIPTION OF THE DRAWINGS

FIG. 1 depicts an embodiment of an electronic device 102 including at least one wireless actuator 104, in a form of a non-wired or unwired button;

FIG. 2 shows an example of a unique acoustic signature 250; and

FIG. 3 is a block diagram of an embodiment of a method of a disclosed electronic device.

### DETAILED DESCRIPTION

It would be beneficial if a button of an electronic device were a wireless actuator. That is, a wireless actuator without an electrical interface to the circuitry of the device, that is located on the housing of the device could provide an acoustic signal with a unique acoustic signature when actuated or released, or a combination of actuated and released. An accelerometer could be used to detect such button presses. Accelerometers are often already in phones and can be used for gesturing, UI experience, camera stabilization, and the like. These same accelerometers could be adapted to be used to detect wireless actuator activations, such as external button presses.

Wireless actuator(s) can include simple tactile generators such as popples that are fixably adhered in any suitable manner, such as to a skin of the housing with no electrical interface to internal hardware. As such, the wireless actuator implementation could be cordless, simple, occupy very little space, be narrow in profile and require no flex or electrical interface. The wireless actuator could be added as an accessory, be embedded or attached to a skin or cover, or be added as an after thought to outside skin of the housing, for example, so that the original housing does not require a redesign. Customization and personalization could be provided for by allowing the placement of the wireless actuator by users in specific locations on or near phones and/or calibrating their response to actuations, presses and/or releases by a user.

In a preferred embodiment, the wireless actuator can include a contactless external popple, for simplifying and/or eliminating circuitry issues such as complex flex to route to external buttons in connection with electronic devices, such as with flip phones, sliders, and the like. Another benefit of the use of popples, for example, is that they can provide substantially consistent acoustic signatures independent of a user's pressing style or actuation characteristic.

Disclosed are electronic devices and methods of electronic devices having a housing including a wireless actuator free from requiring an electrical interface, the wireless actuator located on the housing, protective cover or skin, for example, the wireless actuator being configured to provide tactile feedback and configured to generate an acoustic signal with a unique acoustic signature when actuated, pressed, released or a combination thereof. Included is at least one accelerometer being configured to receive a mechanical or acoustic stimulus and/or an acoustic signal which can include an impulse response being a brief non-periodic and/or non-repeating signal such as a tap or a repeating signal such as a tone, to generate an identifying signal. Also included is a processor configured to receive an identifying signal to generate a control signal based on the received acoustic signal correlated to the acoustic signature. The control signal can provide initiation of any function or application of the device.

Further disclosed are electronic devices with wireless actuators, in a form of keys on or in proximity to an exterior housing that could be manufactured with any variety of specifications, and may be positioned or located on the device in any suitable manner. For example, different sizes, in different locations, i.e., on any part of a face of the device, of different characteristics, designed for different vibration signature, of different material, different orientation, applied on a face so as to excite in the direction or directions of predetermined x, y, z orientations, or any combination of these factors are within the scope of this discussion.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

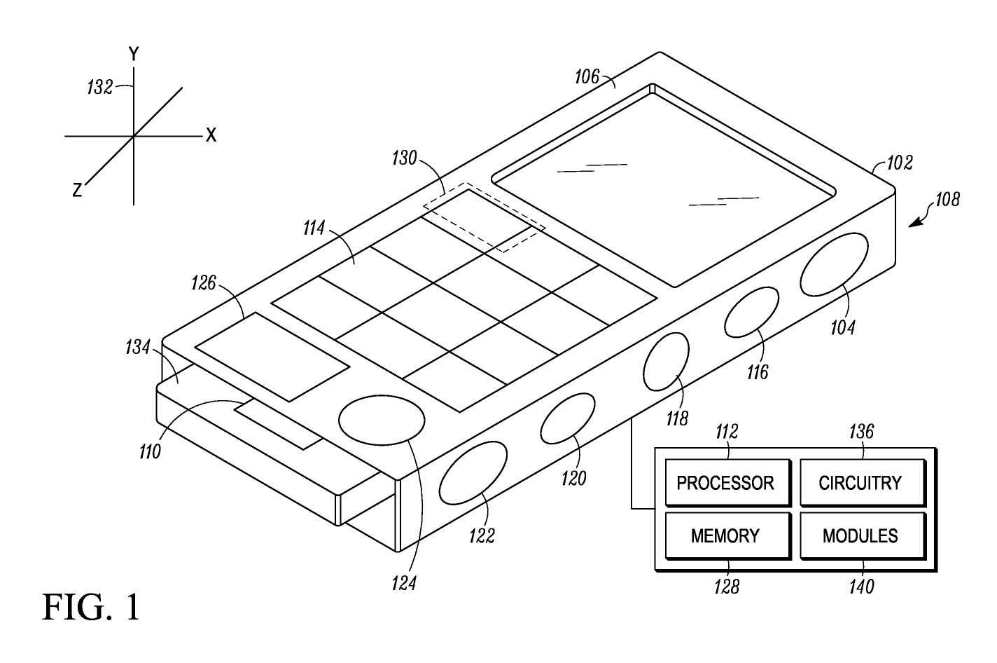

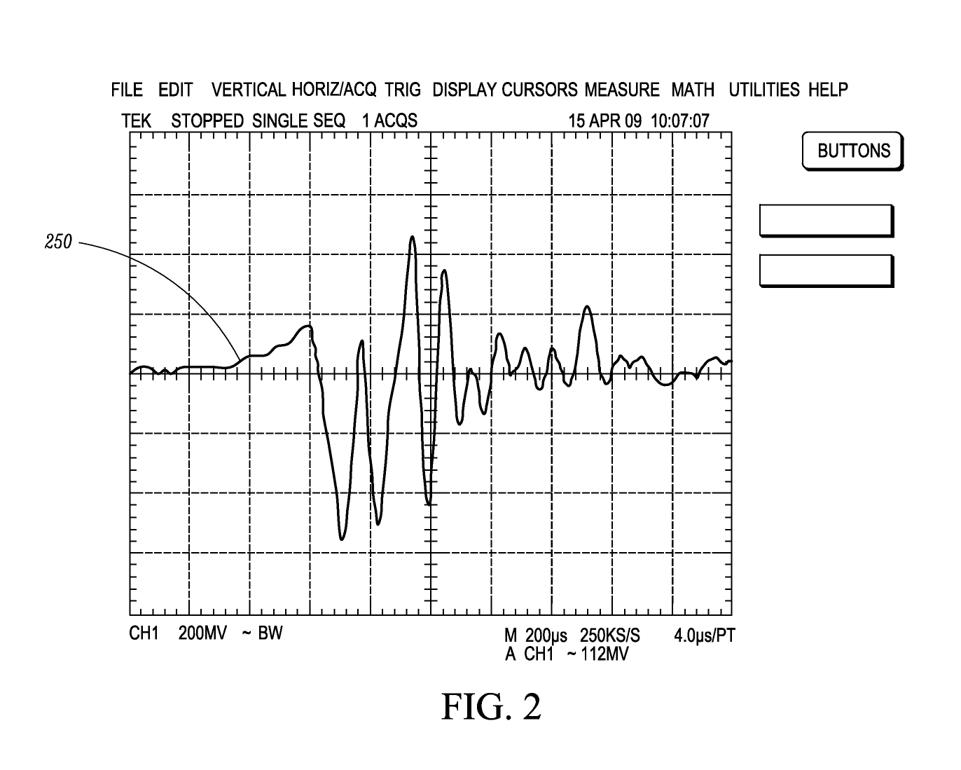

FIG. 1 depicts an embodiment of an electronic device 102 including at least one wireless actuator 104. The wireless actuator 104 is shown without an electrical interface. The wireless actuator 104 can be located on the housing 106, and is configured to provide tactile feedback to a user and configured to generate an acoustic signal (see FIG. 2) with a unique acoustic signature when pressed or actuated, for example, in the direction indicated by the arrow 108. An accelerometer 110 is configured to receive an acoustic signal and to generate an identifying signal. A processor 112 is configured to receive an identifying signal to generate a control signal based on the received acoustic signal correlated to the acoustic signature.

To assist a reader, a few definitions are provided below.

As used herein, the term “wireless actuator”, includes its common ordinary meaning. For example, a wireless actuator includes an actuator free from being electrically connected to the electronic device 102. The wireless actuator is further configured to provide tactile feedback to a user and configured to generate an acoustic signal with a unique desired acoustic signature when actuated.

The term “tactile”, includes its common ordinary meaning. For example, tactile means; (i) Perceptible to the sense of touch; tangible; (ii) Used for feeling: a tactile organ; (iii) Of, relating to, or proceeding from the sense of touch; tactual: a tactile reflex.

The term “feedback”, includes its common ordinary meaning. For example, feedback means: (i) the return of a portion of the output of a process or system to the input, especially when used to maintain performance or to control a system or process. The portion of the output so returned; (ii) feedback in connection with haptic effect feedback related to actuators, such as mechanical and electromechanical buttons, switches, touch surfaces and the like.

Likewise, as used herein, the term “tactile feedback”, includes its common ordinary meaning. For example, tactile feedback relating to electronic gaming industry, refers to tactile feedback technology for use in connection with electronic devices, that provides a physical sensation, tactile or touch feedback. For example, when a touch surface (ie. wireless actuator herein) is actuated, the actuator returns a click, tactile snap, popple click or snap, spring back or haptic feedback, which can provide a user with a typing feel or response, thus providing a user with confidence that the surface touched was in fact properly activated, due to a positive haptic or vibratory feedback. In operation, tactile feedback can provide a user with a feeling of confidence that the activated actuator, was properly activated, due to a positive haptic effect feedback and/or physical sensation.

The wireless actuator can vary widely. In one embodiment, the wireless actuator includes a mechanical wireless actuator that induces or generates a certain vibration when actuated. The wireless actuator can include, for example, a key, a toggle switch, a button, a depressible button that is actuated upon a certain threshold depressing action, a spring release switch and the like. In a preferred embodiment, a popple is utilized, because of its small size, narrow profile and substantially consistent acoustic signal, for example.

The device 102 may be implemented as a cellular telephone (also called a mobile phone). The mobile communication device 102 represents a wide variety of devices that have been developed for use within various networks. Such handheld communication devices include, for example, cellular telephones, messaging devices, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment.

A wireless actuator 104 is distinct, for example, from the wired keypad 114. In FIG. 1, the wireless actuator is shown as item 104, and a plurality of any suitable number of wireless actuators 116, 118, 120, 122, 124 and 126, without electrical interfaces, located on the housing 106 may also be included. Each of the plurality can be configured to provide tactile feedback and configured to generate an acoustic signal (see FIG. 2) with a unique acoustic signature when pressed. A memory 128 can include a look-up table including data to correlate an acoustic signature to an identifying signal of a particular wireless actuator 104.

In a preferred embodiment, the electronic device 102 includes a plurality of wireless actuators 104 without electrical interfaces located on the housing, each of the plurality of wireless actuators configured to provide tactile feedback and configured to generate an acoustic signal with a unique acoustic signature with respect to other of the plurality of wireless actuators, when actuated. Stated differently, each wireless actuators 104 has a unique signature with respect to each other, for improved, distinct, and distinguished identifying signals of which wireless actuator, of the plurality of wireless actuators, was activated.

The detection of a unique acoustic signature of wireless actuators, such as popples, keys, switches, etc., may be achieved by using different size wireless actuators, or wireless actuator with different materials, different design responses, different placement locations, different form factors, and the like. A wireless actuator, such as a popple is a sort of spring. In a preferred embodiment, one can vary the parameters of a popple size, shape, materials, thickness, and the like to create different forcing functions. Popple actuation is provided by pressing/releasing or a combination of pressing and releasing. A popple can provide tactile feed back and generate unique miniscule vibrations that can be picked up by an accelerometer or multiple accelerometers for better resolution. As should be understood by those skilled in the art, while this discussion refers to popples, a variety of other suitable wireless actuator designs can be used.

It is preferable, in accordance with the wireless actuator design, that the wireless actuator provide tactile feedback to actuation or presses, for example. It is also preferable that the wireless actuator(s), provide substantially minimized errors and minimized non-repeatable press characteristics that could be introduced by the user. For example, when a wireless actuator is actuated by a user's finger nail or a much softer finger pad, the differences in the acoustic signal may include a difference in amplitude, phase, and/or frequency. Such differences are preferably minimized in the wireless actuator design herein, to avoid falsing and/or indistinguishable activation. Preferably, a wireless actuator, when in the form of a popple, is designed so that the force to push a popple is approximately 150 grams per meters squared. Also, preferably, the haptic feedback that the user experiences with a wireless actuator is substantially uniform.

Wireless actuators that have the right stiffness to minimize finger press or actuation influence on actuation response, for repeatability, could be beneficial so that each actuation produces a unique vibration/response when actuated, pressed or released, based on their size, construction, and location.

For example, wireless actuators 104 and 122 may have the same overall size but may have different form factors (which in the figure their form factors are indistinguishable due to the constraints of the illustration). Wireless actuator differences may be achieved by using more distinguishable wireless actuator form factors.

As discussed above, in a preferred embodiment, a plurality of wireless actuators can be different from one another in at least one of size, material, location, orientation, form factor, thickness, and design response, their integrated time delay and/or or coded electromechanical response, in addition to other distinguishing features.

The speed of actuation or pressing may change the acceleration waveform of the acoustic signal with a unique acoustic signature. The acceleration waveform may be user dependent. Calibration on a per device or phone basis may be provided. In one embodiment, the calibration may take place in the factory, distribution or other market channel location. This could also be user settable similar to user storing his/her own fingerprint copies in a device, such as a phone, for later authentication/access. For example, for different wireless actuators, the vibration may be transmitted from the housing 106, through the interior to the PCB 134 where one or more accelerometers 110 are located. Depending on the tightness of the tolerances of assembly of the device 102 there may be variation as to what the accelerometers 110 will detect or see.

In another embodiment, a user may calibrate the device. Users use devices in different ways. If the user wraps his whole hand around the device or phone, the boundary conditions (and most likely the acceleration response) will be different than when a user is holding the phone at the edges with 2 hands, for example when messaging. It would be beneficial to avoid a time lag in processing the acoustic signal. An algorithm to distinguish an acoustic signal may be beneficial. Algorithm modules 140 may provide suitable code for processing as well as other functions and applications.

The modules 140 can carry out certain processes of the methods as described herein. The modules can be implemented in software, such as in the form of one or more sets of pre-stored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

In another embodiment, a user may be able to attach one or more wireless actuators to the device 102 and then calibrate the device 102. Whether the one or more wireless actuators are adhered or attached to the device in the factory, distribution or other market channel location, or by the user, such as by utilizing a protective cover or skin, etc., the method of attaching the wireless actuator may vary. One or more wireless actuators can be attached to the housing 106 by recessing them into housing, or double-sided adhesive, or recessed, or the like.

As discussed above, different locations for the same or similar wireless actuators, for example, wireless actuators 104 and 112, and wireless actuators 116 and 120, may provide a different identifying signal based upon their locations in relation to one or more accelerometers 110 and 130. If a high number of wireless actuators are implemented where unique responses may become less and less distinguishable, one or more accelerometers 110 and 130 may be assisted by other sensors in predicting the device context and disabling some of the wireless actuator functionality based on use. For example, if the device 102 is placed up side down on a table, then a key press by the user is most likely to target the sides or back of the phone so the front wireless actuators 124 and 126 are inactive.

In one embodiment, a large wireless actuator 104 and a small wireless actuator 116 are positioned on the side of the housing for up and down volume keys. When the large wireless actuator 104 is pressed or actuated, an accelerometer 110 located inside the device 102 can detect a lower vibration (lower frequency) than that of the smaller wireless actuator 116. In another embodiment, same size wireless actuators 116 and 120 can be used as well in which an accelerometer 110 detects wireless actuator responses coming from different wireless actuator locations and/or orientations.

As mentioned above, included is at least one accelerometer 110 being configured to receive a mechanical or acoustic stimulus and/or and acoustic signal which can include an impulse response being a brief non-periodic and/or non-repeating signal such as a tap or a repeating signal such as a tone, to generate an identifying signal. Also included is a processor configured to receive an identifying signal to generate a control signal based on the received acoustic signal correlated to the acoustic signature. The control signal can provide initiation of any function or application of the device.

The use of multiple accelerometers may help by conducting single dimensional, two dimensional or xyz coordinates 132 measurement of response amplitude and polarity. Placing wireless actuators on different planes where initiated vibrations are in different planes may be detected by a multi-dimensional accelerometer. Of course, an accelerometer may be dimension neutral as well. Furthermore, placing wireless actuators on different planes could make detection easier due to acoustic signatures being more distinct.

Accelerometers can have a wide bandwidth in the KHz, and can be sampled fast enough to catch the wireless actuator, such as a popple press in one embodiment, with a high sensitivity (˜10 bit A/D outputs or more). Conducting Fourier transform to measure a popple response spectrum may include a sampling rate of at least twice the highest detection frequency (1600 Hz in this case). The sensitivity to detect minor vibrations and 10 Bit A/D may be adequate.

In one embodiment, a lookup table stored in memory 128 can be used to store wireless actuator response characteristics as measured by one or more internal accelerometers 110 and/or 130 so that the processor 112 decides based on a lookup table match with which wireless actuator or which button is actuated, pressed, released or a combination thereof. Characteristics can include, for example, spectrum, phase and amplitude. A look up table stored in memory 128 could be downloaded or generated and stored inside device 102.

Testing of a prototype electronic device can provide mapping a wireless actuator response to a location and determine acoustic signature data which can be stored in a look up table that may be stored in an electronic device. Analysis of the identifying signal may be based on wireless actuator distance, location, and orientation, such as x, y, z coordinates 132 as determined by one or more accelerometers 110 and 130. Also considered may be the use of multiple accelerometers for triangulation measuring different characteristics, such as relative amplitude and frequency responses. One or multiple accelerometers for differential tracking may be, for example, mounted on a PCB 134 and integrated with circuitry 136 of the device. It is understood that any number and type of accelerometers are within the scope of this discussion, and that such may provide varying levels of sensitivity to an acoustic signal with a unique acoustic signature.

FIG. 2 shows an example of a unique acoustic signature 250. The use of one or more existing accelerometers of a device 102 to pick up acceleration waveform 250 associated with a popple 104 click elsewhere on a phone and interpret it as a key press, given that the acceleration profile matches that of a pre-stored waveform of a true key click, can be processed to generate a control signal based on the received acoustic signal correlated to the acoustic signature. A Fast Fourier Transform (FFT) or other mathematical algorithm may determine the spectrum (frequency/phase) of a signal or any other suitable result. As discussed above, software to correlate vibration signature to key intent may be provided as well as a look up table, like codec.

Other means to differentiate wireless actuators could be provided. For example, in one embodiment, other means can include that a popple signal has integrated in it a certain delay function where acoustic signature is detected after a fixed interval following finger unpress and that delay is intentionally different from popple to popple to be able to differentiate between them. Other means can also include that a popple signal has integrated in it a certain coding function (such as a coded electro-mechanical signal following a key press/or release where acoustic signature is set by the coding signal which is intentionally different from popple to popple to be able to differentiate between them). It may be beneficial to take into account that the pressing action may cause a secondary sequence of events/responses enabled by the popple specific design.

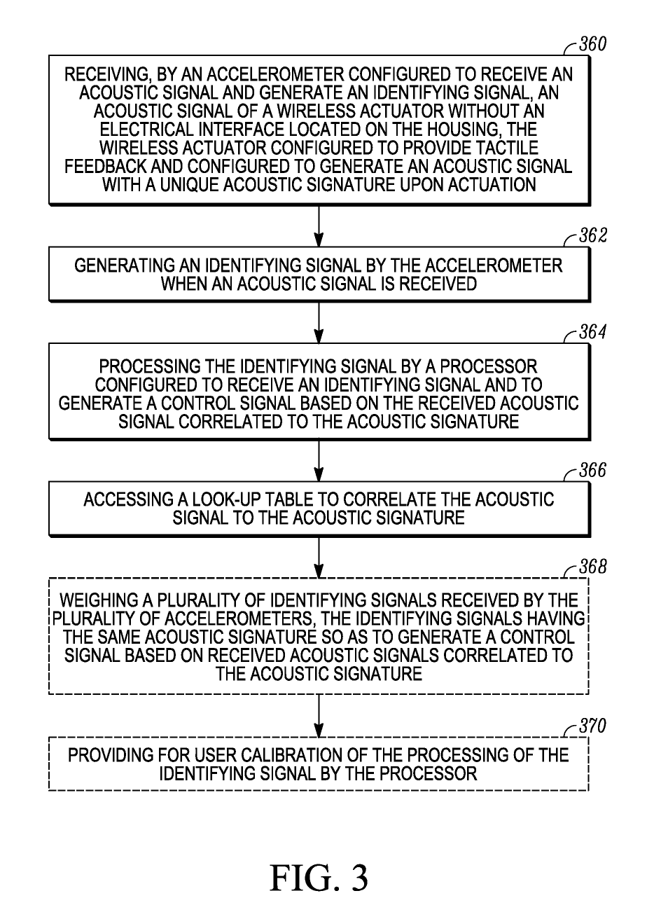

FIG. 3 is an embodiment of a method of a disclosed electronic device where the modules 140 can carry out certain processes of the methods as described. The method includes receiving, by an accelerometer configured to receive an acoustic signal and generate an identifying signal, an acoustic signal of a wireless actuator without an electrical interface located on the housing, the wireless actuator configured to provide tactile feedback and configured to generate an acoustic signal with a unique acoustic signature when actuated 360. The method as described above also includes generating an identifying signal by the accelerometer when an acoustic signal is received 362 and processing the identifying signal by a processor configured to receive an identifying signal and to generate a control signal based on the received acoustic signal correlated to the acoustic signature 364.

In one embodiment, accessing a look-up table to correlate the acoustic signal to the acoustic signature 366 can provide wireless actuator and control function correlation. As discussed, in another embodiment, a correlating algorithm may provide a wireless actuator and control function correlation.

As discussed in detail above, a plurality of wireless actuators, such as in the form of buttons and/or accelerometers may be included with the device. An embodiment of the method of the electronic device can include weighing a plurality of identifying signals received by the plurality of accelerometers, the identifying signals having the same acoustic signature so as to generate a control signal based on received acoustic signals correlated to the acoustic signature 368. In yet another embodiment, the method can include providing for user calibration of the processing of the identifying signal by the processor 370.

The disclosed devices and method provide an electronic device were a wireless actuator without an electrical interface to the circuitry of the device, that is located on the housing of the device could provide an acoustic signal with a unique acoustic signature when actuated. An accelerometer could be used to detect such actuation. In a preferred embodiment and as detailed previously, a wireless actuator in the form of a contactless external popple may simplify circuitry issues such as complex flex to route to external buttons with flip phones, sliders, and the like.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. An electronic device having a housing, comprising:
a wireless actuator without an electrical interface, the wireless actuator located on the housing, the wireless actuator configured to provide tactile feedback and configured to generate an acoustic signal with a unique acoustic signature when actuated;
an accelerometer configured to receive an acoustic signal and to generate an identifying signal; and
a processor configured to receive an identifying signal to generate a control signal based on the received acoustic signal correlated to the acoustic signature.

2. The electronic device of claim 1 further comprising:
a plurality of wireless actuators without electrical interfaces located on the housing, each of the plurality of wireless actuators configured to provide tactile feedback and configured to generate an acoustic signal with a unique acoustic signature with respect to other of the plurality of wireless actuators, when actuated.

3. The electronic device of claim 1 further comprising:
a plurality of wireless actuators without electrical interfaces wherein the plurality of wireless actuators are different from one another in at least one of size, material, location, orientation, form factor, thickness, and design response, integrated time delay, and coded electromechanical response.

4. The electronic device of claim 1 wherein the accelerometer is at least an one-dimensional accelerometer.

5. The electronic device of claim 1 further comprising a plurality of accelerometers.

6. The electronic device of claim 1 further comprising:
a memory including a look-up table including data relating to a plurality of acoustic signatures.

7. The electronic device of claim 1 wherein the wireless actuator is a popple.

8. The electronic device of claim 1 wherein the wireless actuator is configured to be connected in proximity to the housing.

9. The electronic device of claim 1 wherein the housing is recessed to receive the wireless actuator.

10. An electronic device having a housing, comprising:
a plurality of wireless actuators without electrical interfaces located on the housing, each of the plurality configured to provide tactile feedback and configured to generate an acoustic signal with a unique acoustic signature upon actuation;
an accelerometer configured to receive an acoustic signal and to generate an identifying signal based on a received acoustic signal; and
a processor configured to receive an identifying signal;
a memory including a look-up table including data to correlate an acoustic signature to an identifying signal.

11. The electronic device of claim 10 wherein the plurality of wireless actuators are different from one another in at least one of size, material, location, orientation, plane of placement on the housing, form factor, and design response.

12. The electronic device of claim 10 wherein the accelerometer is at least an one-dimensional accelerometer.

13. The electronic device of claim 10 further comprising a plurality of accelerometers.

14. The electronic device of claim 10 wherein the wireless actuators are popples.

15. A method of an electronic device having a housing, comprising:
receiving, by an accelerometer configured to receive an acoustic signal and generate an identifying signal, an acoustic signal of a wireless actuator without an electrical interface located on the housing, the wireless actuator configured to provide tactile feedback and configured to generate an acoustic signal with a unique acoustic signature upon actuation;
generating an identifying signal by the accelerometer when an acoustic signal is received; and
processing the identifying signal by a processor configured to receive an identifying signal and to generate a control signal based on the received acoustic signal correlated to the acoustic signature.

16. The method of claim 15, further comprising:
accessing a look-up table to correlate the acoustic signal to the acoustic signature.

17. The method of claim 15 wherein the accelerometer is at least an one-dimensional accelerometer, the method further comprising:
determining the characteristics of the acoustic signal relative to at least one dimension.

18. The method of claim 15 wherein the electronic device wherein the electronic device includes a plurality of accelerometers, each configured to receive an acoustic signal and generate an identifying signal, the method further comprising:
weighing a plurality of identifying signals received by the plurality of accelerometers, the identifying signals having the same acoustic signature so as to generate a control signal based on received acoustic signals correlated to the acoustic signature.

19. The method of claim 15 further comprising:
receiving, by an accelerometer configured to receive an acoustic signal and generate an identifying signal, a plurality of acoustic signals by different wireless actuators without electrical interfaces located on the housing, the wireless actuators configured to provide tactile feedback and configured to generate acoustic signals, each with a unique acoustic signature, upon actuation.

20. The method of claim 15 further comprising:
providing for user calibration of the processing of the identifying signal by the processor.
